(19) United States
(12) Patent Application Publication
(10) Pub. No.: US 2007/0079558 A1
(43) Pub. Date: Apr. 12, 2007

(54) Apparatus, in particular for forks of forklift trucks

(75) Inventor: Pietro Foroni, Casalpusterlengo (LO) (IT)

Correspondence Address: NIXON & VANDERHYE, PC, 901 NORTH GLEBE ROAD, 11TH FLOOR, ARLINGTON, VA, 22203, US

(73) Assignee: BOLZONI S.p.A., Casoni di Podenzano (PC) (IT)

(21) Appl. No.: 11/543,243

(22) Filed: Oct. 5, 2006

(30) Foreign Application Priority Data
Oct. 11, 2005 (IT) MO2005A000260

(51) Int. Cl. E05F 11/38

(52) U.S. Cl. 49/375

(57) ABSTRACT

An apparatus for providing with two pairs of forks a front part of a forklift truck comprises first profiled elements for supporting a pair of external forks and second profiled elements for supporting a pair of internal forks, a guide device that receives internally both said first profiled elements and said second profiled elements.

### CROSS REFERENCE TO RELATED APPLICATION

This application is a new U.S. utility application claiming benefit of IT MO2005A000260 filed Oct. 11, 2005, the entire contents of which are hereby incorporated by reference.

The invention relates to an apparatus, in particular for forks of forklift trucks.

### BACKGROUND OF THE INVENTION

Prior art comprises an apparatus for moving the forks of forklift trucks, comprising a fixed frame that in use is mounted on the front part of a forklift truck and which has distinct pairs of guides on which respective pads slide on which the forks are mounted. In particular, a pair of guides is provided for the pads of the more external pair of guides and a further pair of guides for the pads of the more internal pair of guides.

Apparatuses are further known in which the external forks are mounted on profiled elements that act as a guide and support for internal forks or, —viceversa—in which the internal forks are mounted on profiled elements that act as a guide or support for the external forks.

Prior-art apparatuses have the drawback of having a certain overall dimensions in height or depth and, therefore, such apparatuses considerably limit the working zone visible for an operator sitting on the forklift truck.

Therefore, an object of the invention is to improve known apparatuses.

A further object is to find an apparatus for auxiliary tools of forklift trucks that provides better visibility of the work zone.

### BRIEF DESCRIPTION OF THE DRAWINGS

The invention can be better understood and implemented with reference to the attached drawings, that show an embodiment thereof by way of non-limiting example, in which:

FIG. 1 is a perspective view of an apparatus for forklift trucks on which two pairs of forks are mounted;

FIG. 2 is a cross section of the guide device of the apparatus in FIG. 1.

### DESCRIPTION OF THE INVENTION

According to the invention, there is provided an apparatus, comprising first profiled elements for supporting a pair of external forks and second profiled elements for supporting a pair of internal forks, a guide device for guiding said first profiled elements and said second profiled elements, characterised in that said guide device receives both said first profiled elements and said second profiled elements. Owing to the invention, it is possible to obtain an overall height of the forklift truck that is much less than that of known apparatuses.

In fact, the guide device is common to the first and to the second profiled elements and therefore the structure of the guide device is very compact.

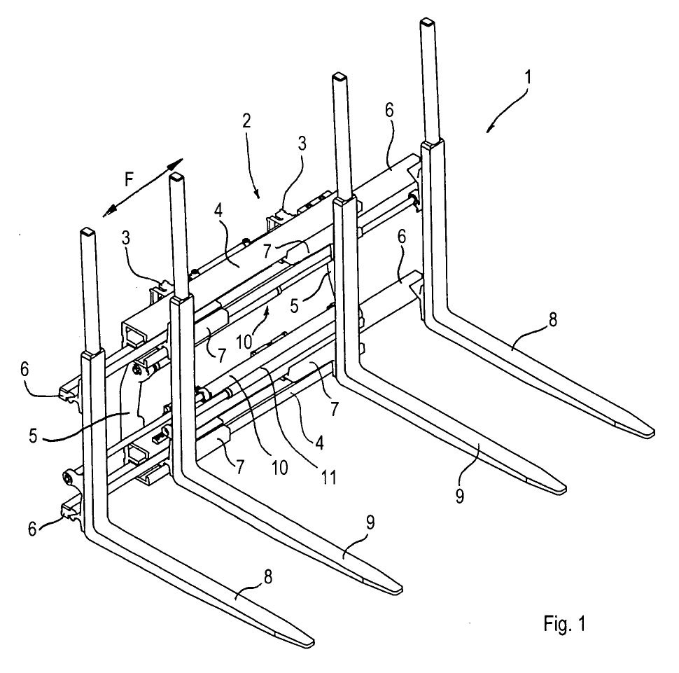

As shown in FIG. 1, an apparatus 1 comprises a frame 2 that is mountable on the front part of a forklift truck by means of a suitable fixing device 3. The frame 2 is formed by a pair of crosspieces 4, which are parallel to one another and in use generally lie parallel to the ground, the crosspieces 4 being connected together by means of a pair of uprights 5.

Each crosspiece 4 is formed by an internally hollow profiled body for receiving first profiled elements 6 and second profiled elements 7.

The first profiled elements 6 are divided into two pairs that occupy corresponding and opposite longitudinal zones of the crosspieces 4, on each pair of the first profiled elements 6 there being mounted an external fork 8 of a pair of external forks.

The second profiled elements 7 are also divided into two pairs that occupy corresponding and opposite longitudinal zones of the crosspieces 4, on each pair of the second profiled elements 7 there being mounted an internal fork 9 of a pair of internal forks.

Between each external fork 8 and the frame 2 there is mounted a hydraulic actuator 10 that enables each external fork 8 to be moved from an extended position further from the frame 2 to a retracted position nearer the frame 2, and viceversa.

Between each internal fork 9 and the frame 2 there is mounted a gas spring 11 by means of which each internal fork 9 is movable along the crosspieces 4 to follow the movements of the respective external fork 8 that are caused by the actuator 10, as explained above.

Furthermore, the frame 2 can be moved sideways with respect to the forklift truck along the direction indicated by the arrow F, with the aid of known movement devices.

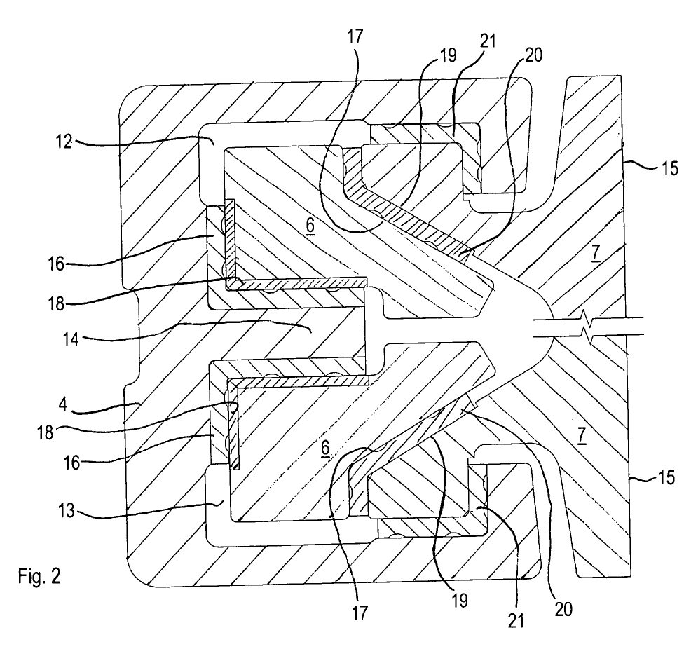

As shown in greater detail in FIG. 2, each crosspiece 4 has a substantially “E”-shaped cross section and has a first chamber 12 and a second chamber 13 between which there is interposed a rib 14. In each chamber 12, 13 there are slidingly received, at both the longitudinal portions of each crosspiece 4, both the first profiled elements 6 and the second profiled elements 7, the latter being provided in the face further from the crosspieces 4 with coupling surfaces 15 on which the internal forks 9 are mountable. The first profiled elements 6 and the second profiled elements 7 have respective conjugated cross sections, i.e. such shaped as to substantially occupy each of the chambers 12, 13 in such a way as to form an assembly of slidable parts sliding on one another along the longitudinally extending direction of each crosspiece 4. More in particular, the first profiled elements 6 have a right edge 18 coupled by means of a first sliding pad 16 with a zone of the chamber 12, 13 near the rib 14 and an oblique side 17 opposite the edge 18 slidably coupled to a correspondingly oblique side 19 of the second profiled elements 7. Between the conjugated surfaces defined by the oblique sides 17, 19 there is interposed a second sliding pad 20.

Further, each second profiled element 7 has a right edge 21 that is coupled with the respective chamber 12, 13 in a zone diagonally opposite the first sliding pad 16.

1. Apparatus, comprising first profiled elements for supporting a pair of external forks and second profiled elements for supporting a pair of internal forks, a guide device for guiding said first profiled elements and said second profiled elements, wherein said guide device receives both said first profiled elements and said second profiled elements.

2. Apparatus according to claim 1, wherein said first profiled elements and said second profiled elements are contained inside chambers of said guide device.

3. Apparatus according to claim 1, wherein said chambers longitudinally occupy crosspiece elements of said guide device.

4. Apparatus according to claim 3, wherein said first profiled elements and said second profiled elements have respective cross sections conjugated to each chamber of said chambers.

5. Apparatus according to claim 3, wherein said guide device has a rib interposed between said chambers.

6. Apparatus according to claim 4, wherein said guide device has a rib interposed between said chambers.

7. Apparatus according to claim 5, wherein said first profiled elements has an edge slidingly coupled with each chamber of said chambers near said rib.

8. Apparatus according to claim 7, wherein each first profiled element has a sliding surface facing a conjugated surface of a corresponding second profiled element.

9. Apparatus according to claim 8, wherein said second profiled element has an edge engaged against an angular zone of the respective chamber diagonally opposite said rib.
